(19) United States
(12) Patent Application Publication
(10) Pub. No.: US 2010/0264572 A1
(43) Pub. Date: Oct. 21, 2010

(54) SHOCK MOUNT ASSEMBLY AND DETECTOR INCLUDING THE SAME

(75) Inventor: Nicholas Ryan Konkle, Waukesha, WI (US)

Correspondence Address: DEAN D. SMALL;THE SMALL PATENT LAW GROUP LLP, 225 S. MERAMEC, STE. 725T, ST. LOUIS, MO, 63105, US

(73) Assignee: GENERAL ELECTRIC COMPANY, Schenectady, NY (US)

(21) Appl. No.: 12/426,416

(22) Filed: Apr. 20, 2009

(51) Int. Cl. F16F 1/00; F16F 7/00; H01J 5/02

(52) U.S. Cl. 267/182; 267/141.5; 250/239

(57) ABSTRACT

A shock mount assembly includes a base member, a top member, and an isolator disposed between the base member and the top member, the isolator providing a dynamic stiffness in three different directions to limit the movement, deflection, and/or acceleration of a detector array with respect to a casing surrounding the detector array in three dimensions. A detector array including the shock mount assembly is also described herein.

### BACKGROUND OF THE INVENTION

The subject matter disclosed herein relates generally to detector devices, and more particularly to an apparatus providing shock protection to electronic assemblies in a detector device.

In various portable x-ray medical imaging applications, an air-cooled x-ray detector is sealed in an external casing that is typically formed of metal. The x-ray detector includes a detector array that is formed on a breakable glass panel. The detector array is affixed directly or indirectly to a circuit board that includes heat generating components. If the x-ray detector is dropped, a shock is delivered to the external casing. The resultant shock may cause the detector array to contact the external casing and thus damage the detector array. As such, isolation of the detector array relative to the external casing is required to isolate the detector array from shock.

Additionally, the x-ray detector includes a thermal interface to facilitate conducting heat away from the heat generating components. The heat generating components are thermally coupled to the casing via a thermal compound that is not shear resistant, meaning that the thermal coupling can be broken when shear forces are applied. Thus, if the x-ray detector experiences a shock event, the thermal interface may be subjected to shear loading and may become less effective at conducting heat.

In order to isolate the x-ray detector array from mechanical shock loading and thermally manage component and x-ray detector temperatures, a number of shock mounts are used. The shock mounts need to fit in the limited amount of space within the detector and enable the detector array to move relative to the external casing to some extent while absorbing a shock load to reduce maximum acceleration delivered to the detector array.

### BRIEF DESCRIPTION OF THE INVENTION

In one embodiment, a shock mount assembly is provided. The shock mount assembly includes a base member, a top member, and an isolator disposed between the base member and the top member. The isolator has a dynamic stiffness that is selected to provide a dynamic stiffness in three different directions to limit the movement, deflection, and/or acceleration of a detector array with respect to a casing surrounding the detector array in three dimensions.

In another embodiment, a detector array is provided. The detector array includes an electronic assembly is provided. The electronic assembly includes a panel and a circuit board. The detector array also includes a panel support rigidly coupled to the electronic assembly, a casing surrounding the electronic assembly and the panel support, and a flexible shock mount coupled between the panel support and the casing. The flexible shock mount having providing a dynamic stiffness in three axisymmetric directions.

In another embodiment, a method of dampening shock forces applied to a detector is provided. The detector includes an electronic assembly including a panel and a circuit board, a panel support rigidly coupled to the electronic assembly, and a casing surrounding the electronic assembly and the panel support. The method includes determining a distance between the panel and the casing, and configuring an isolator to have a dynamic stiffness that provides dynamic stiffness in three different directions, the dynamic stiffness being selected to limit the movement of the panel with respect to the casing to a quantity that is less than the distance between the panel and the casing.

### BRIEF DESCRIPTION OF THE DRAWINGS

FIG. 1 is a block schematic diagram of an exemplary medical imaging system in accordance with an embodiment of the present invention.

FIG. 2 is a bottom cut-away view of an exemplary enclosed x-ray detector in accordance with an embodiment of the present invention.

FIG. 3 is a side cut-away view of the detector shown in FIG. 2 in accordance with an embodiment of the present invention.

FIG. 4 is a back view of the detector shown in FIG. 2 in accordance with an embodiment of the present invention.

FIG. 5 is a section view of a portion of the detector shown in FIG. 2 in accordance with an embodiment of the present invention.

FIG. 6 is a perspective view of an exemplary shock mount that may be used with the detector shown in FIGS. 4 and 5 in accordance with an embodiment of the present invention.

FIG. 7 is an exploded view of the shock mount shown in FIG. 6 in accordance with an embodiment of the present invention.

FIG. 8 is a side view of a portion of the shock mount shown in FIG. 6 in accordance with an embodiment of the present invention.

FIG. 9 is a cross-sectional view of the shock mount portion shown in FIG. 8 in accordance with an embodiment of the present invention.

FIG. 10 is a side view of a portion of the shock mount shown in FIG. 6 in accordance with an embodiment of the present invention.

FIG. 11 is a cross-sectional view of the shock mount portion shown in FIG. 8 in accordance with an embodiment of the present invention.

FIG. 12 is a cross-sectional view of the exemplary shock mount shown in FIG. 6 in a first operational position in accordance with an embodiment of the present invention.

FIG. 13 is a cross-sectional view of the exemplary shock mount shown in FIG. 6 in a second different operational position in accordance with an embodiment of the present invention.

FIG. 14 is a cross-sectional view of the detector shown in FIG. 3 in accordance with an embodiment of the present invention.

FIG. 15 is a graphical illustration of the effect of tuning the shock mount described herein in accordance with an embodiment of the present invention.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like). Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

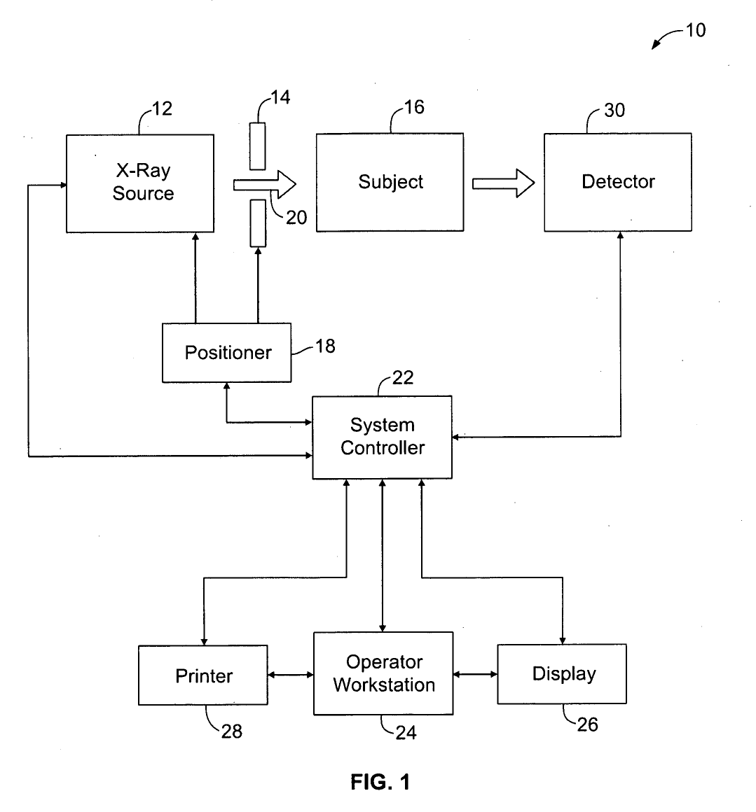

Referring to the drawings, FIG. 1 illustrates a block diagram of a medical imaging system. In the exemplary embodiment, the medical imaging system is a digital radiography imaging system 10. The digital radiography imaging system 10 includes an x-ray source 12, a collimator 14 adjacent to the x-ray source 12, a subject 16 to be imaged, a detector 30, and a positioner 18. The positioner 18 is a mechanical controller coupled to x-ray source 12 and collimator 14 for controlling the positioning of x-ray source 12 and collimator 14.

The digital radiography imaging system 10 is designed to create images of the subject 16 by means of an x-ray beam 20 emitted by x-ray source 12, and passing through collimator 14, which forms and confines the x-ray beam 20 to a desired region, wherein the subject 16, such as a human patient, an animal or an object, is positioned. A portion of the x-ray beam 20 passes through or around the subject 16, and being altered by attenuation and/or absorption by tissues within the subject 16, continues on toward and impacts the detector 30. In an exemplary embodiment, the detector 30 may be a fixed detector or a portable detector. In an exemplary embodiment, the detector 30 may be a digital flat panel x-ray detector. The detector 30 converts x-ray photons received on its surface to lower energy light photons, and subsequently to electric signals, which are acquired and processed to reconstruct an image of internal anatomy within the subject 16.

The digital radiography imaging system 10 further includes a system controller 22 coupled to x-ray source 12, positioner 18, and detector 30 for controlling operation of the x-ray source 12, positioner 18, and detector 30. The system controller 22 may supply both power and control signals for imaging examination sequences. In general, system controller 22 commands operation of the radiography system to execute examination protocols and to process acquired image data. The system controller 22 may also include signal processing circuitry, based on a general purpose or application-specific computer, associated memory circuitry for storing programs and routines executed by the computer, as well as configuration parameters and image data, interface circuits, and so forth.

The system controller 22 may further include at least one processor designed to coordinate operation of the x-ray source 12, positioner 18, and detector 30, and to process acquired image data. The at least one processor may carry out various functionality in accordance with routines stored in the associated memory circuitry. The associated memory circuitry may also serve to store configuration parameters, operational logs, raw and/or processed image data, and so forth. In an exemplary embodiment, the system controller 22 includes at least one image processor to process acquired image data.

The system controller 22 may further include interface circuitry that permits an operator or user to define imaging sequences, determine the operational status and health of system components, and so-forth. The interface circuitry may allow external devices to receive images and image data, and command operation of the radiography system, configure parameters of the system, and so forth.

The system controller 22 may be coupled to a range of external devices via a communications interface. Such devices may include, for example, an operator workstation 24 for interacting with the radiography system, processing or reprocessing images, viewing images, and so forth. In the case of tomosynthesis systems, for example, the operator workstation 24 may serve to create or reconstruct image slices of interest at various levels in the subject based upon the acquired image data. Other external devices may include a display 26 or a printer 28. In general, these external devices 24, 26, 28 may be local to the image acquisition components, or may be remote from these components, such as elsewhere within a medical facility, institution or hospital, or in an entirely different location, linked to the image acquisition system via one or more configurable networks, such as the Internet, intranet, virtual private networks, and so forth. Such remote systems may be linked to the system controller 22 by any one or more network links. It should be further noted that the operator workstation 24 may be coupled to the display 26 and printer 28, and may be coupled to a picture archiving and communications system (PACS). Such a PACS might be coupled to remote clients, such as a radiology department information system or hospital information system, or to an internal or external network, so that others at different locations may gain access to image data. Additionally, although described in a medical setting, it is contemplated that the benefits of the various embodiments of the invention accrue to all medical imaging systems and non-medical imaging systems such as baggage scanning systems used in an airport or a rail station.

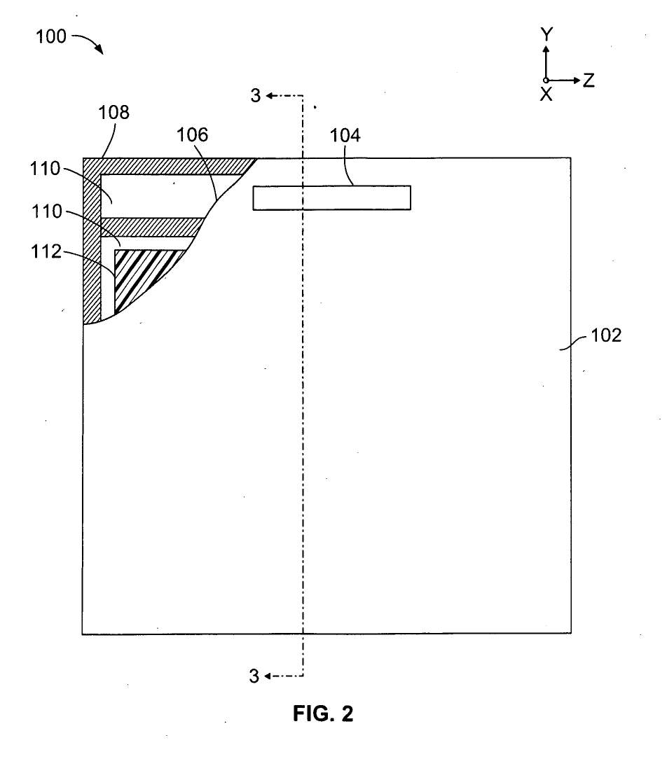

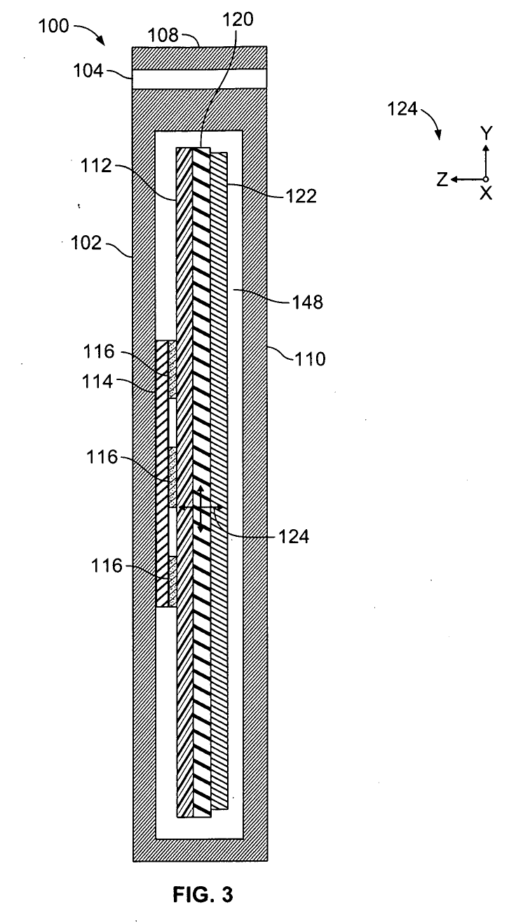

To become familiar with the problems associated with providing shock protection to a detector array, such as the detector 30 shown in FIG. 1, reference is now made to FIG. 2 and FIG. 3. The apparatus shown in FIG. 2 is a bottom cut-away view of an exemplary enclosed x-ray detector array 100 that may be used in lieu of the detector 30 shown in FIG. 1. Although the shock protection devices described herein are discussed with respect to a detector array that may be installed substantially permanently in a medical imaging system, for example detector array 30, in the exemplary embodiment, the shock protection devices may also be installed in a portable detector that is hand-carried by an operator to various locations to perform medical imaging. Additionally, the portable detector may be mounted on a wheeled cart or other movable apparatus to enable an operator to move the detector from one location to another location. As such, the shock protection systems described herein are applicable to substantially permanently installed detector arrays and portable detector arrays.

As discussed above, the detector array 100 may be coupled to an imaging system such as imaging system 10 or may be a portable detector array. The detector array 100 includes a back cover 102, shown as a surface parallel to the plane of the illustration. Back cover 102 has a slot 104 that can be used to mount, carry and/or store x-ray detector array 100. A corner of back cover 102 is cut away in the illustration as indicated by cut-away line 106. Behind this corner (i.e., above back cover 102) are cover wall 108, cover front 110, and a circuit board 112. Back cover 102, cover wall 108, and cover front 110 together comprise a “casing,” and may be made of a lightweight, low atomic number (N) material, such as aluminum, or a graphite material. Graphite has a lower weight than aluminum, but it is also stiffer and less energy-absorbent.

FIG. 3 is a side cut-away view of the enclosed x-ray detector array 100 of FIG. 2 viewed along the line 3-3 of FIG. 2. An example of a shock force applied to the x-ray detector array is shown with arrows 124 that indicate that shock may occur along an X-Y axis, e.g. top-to-bottom, or along a Z-axis, e.g. front-to-back as a result of the application of this shock. Circuit board 112 is affixed (e.g., using an adhesive) to a panel support 120 that may be fabricated from a low N material, which in turn is affixed to a panel 122. The panel 122 may be a glass panel and may include x-ray scintillator material. In the exemplary embodiment, the panel 122 is the x-ray detector array that includes a plurality of scintillators. As such, during operation, the panel 122 is formed to include a plurality of detector rows that each include a plurality of detector elements, that together sense the projected x-rays that pass through an object, such as a patient. Each detector element produces an electrical signal that represents the intensity of an impinging X-ray beam and hence allows estimation of the attenuation of the beam as the beam passes through the object. In some embodiments, the panel support 120 is not used, and circuit board 112 is affixed directly to the panel 122. Together, circuit board 112 and panel 122 (and panel support 120, if present) comprise an “electronic assembly.” To provide some degree of break resistance for panel 122, a gap 148 is provided between panel 122 and cover front 110. Also, the electronic assembly is clear of any wall of the casing, but is mounted to back cover 102. Additionally, heat generating components 116 on circuit board 112 are thermally coupled to back cover 102 using a heat conducting compound 114. Heat conducting compound 114 provides, directly or indirectly, a mechanical coupling between circuit board 112 and back cover 102.

The heat conducting compound is needed in some applications of x-ray detector array 100 that provide high-speed readout of pixilated images from detector array 100 and thus generate constant heat that has to be removed. Furthermore, in the exemplary embodiment, the X-ray detector array 100 is portable, but typically large enough to image a significant region of a human patient, such as the patient's chest. Thus, X-ray detector array 100 may be only about one or a few centimeters high, but may be tens of centimeters in width and length. In use, shocks may be applied, accidentally or otherwise, to the x-ray detector 100 from almost any direction. Moreover, the x-ray detector array 100 may be tipped over while in use or even stepped upon. If the electronic assembly including circuit board 112 and panel 122 moves relative to back cover 102 (e.g., about 3 mm), the panel 122 may break and/or the heat conducting compound 114 may be subject to severe shear loading and may fail and become ineffective.

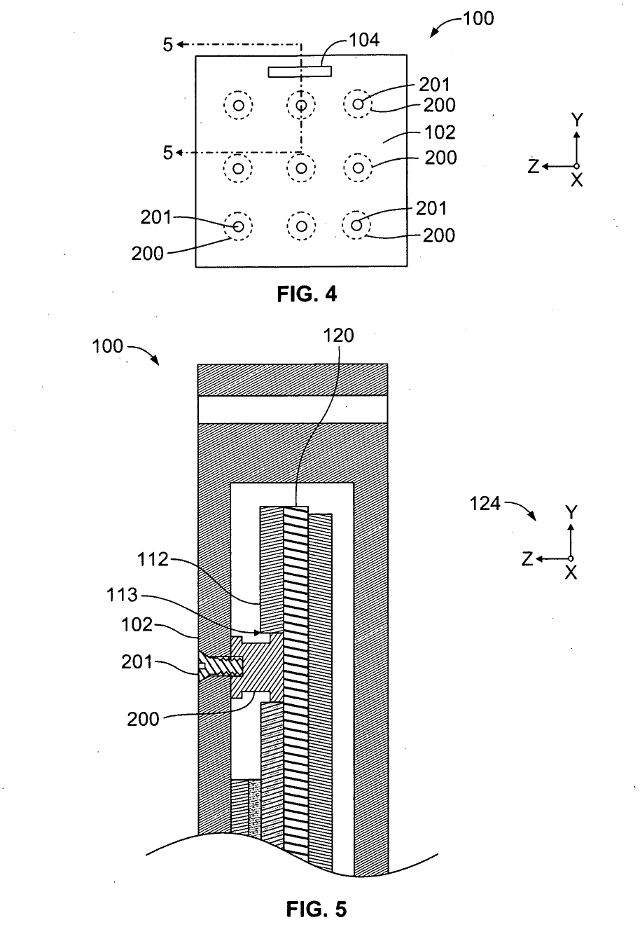

To reduce the likelihood or to avoid the effects from a shock event, the detector 100 includes a plurality of shock mounts 200. For example, FIG. 4 is a back view of the detector 100 illustrating the locations of a plurality of flexible shock mounts 200 that are adapted to have a dynamic stiffness that is selected to provide dynamic stiffness in three axisymmetric directions, such as the X, Y, and Z directions. For example, if the electronic assembly is separated from the casing by a distance X1 in the X direction, by a distance Y1 in the Y direction, and a distance Z1 in the Z direction, then the shock mount isolator is selected to have a dynamic stiffness to prevent the electronic assembly from contacting the detector casing in the X, Y, and Z directions. In one embodiment, the distances X1, Y1, and Z1 are different distances. In another embodiment, at least two of the distances are substantially the same such that the shock mount 200 has a dynamic stiffness that is approximately the same in at least two directions. In another embodiment, the distances X1, Y1, and Z1 are substantially the same such that the shock mount 200 provides a dynamic stiffness that is approximately the same in all three directions. In the exemplary embodiment, the detector 100 includes nine shock mounts 200 disposed in a grid pattern. As shown in FIG. 4, in some exemplary embodiments, the shock mounts 200 are arranged in three rows and three columns. Optionally, more or fewer than nine shock mounts 200 may be utilized. For example, the shock mounts 200 may be arranged in four rows and three columns, e.g. twelve shock mounts 200, or four rows and four columns, e.g. sixteen shock mounts 200, etc.

FIG. 5 is a section view of a portion of the detector 100 (viewed along section line 5-5 of FIG. 4). As shown in FIG. 5, each flexible shock mount 200 is mounted between the back cover 102 and the panel support 120 and has a dynamic stiffness that is selected to provide a dynamic stiffness in three different directions to limit the movement, deflection, and/or acceleration of the electronic assembly, including the detector array, with respect to a casing surrounding the detector array in three dimensions. More specifically, the circuit board 112 includes at least one opening 113 extending therethrough that is sized to enable at least a portion of the shock mount 200 to be disposed proximate to and therefore directly coupled to the panel support 120. As shown in FIG. 5, a portion of each flexible shock mount 200 is coupled to the back cover 102 via a fastener 201 such as a bolt or screw, for example.

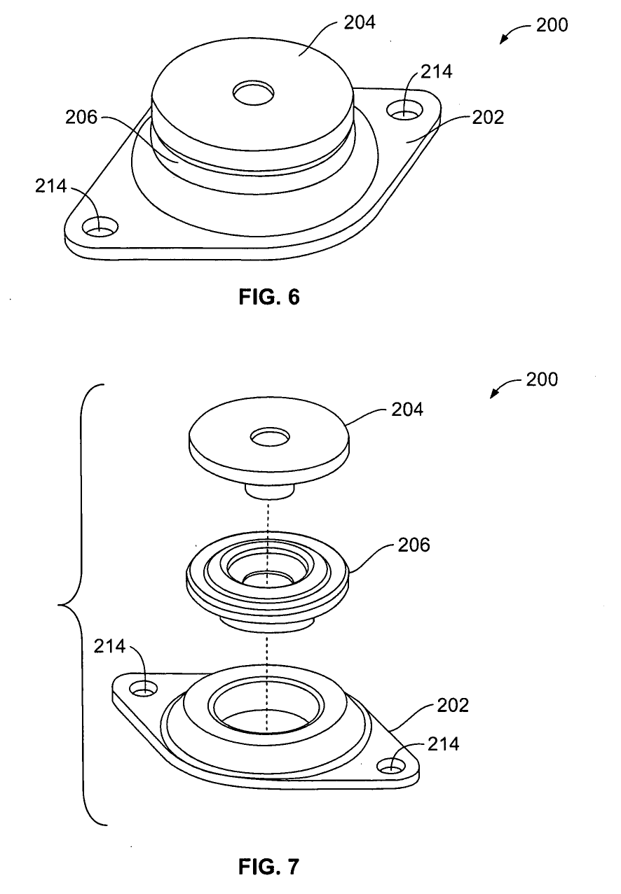

FIG. 6 is a perspective view of an exemplary shock mount 200 that may be used with the detector 100 as shown in FIGS. 4 and 5. FIG. 7 is an exploded view of the shock mount 200 shown in FIG. 6. In the exemplary embodiment, the shock mount 200 includes a base member 202, a top member 204, and an isolator member 206 that is disposed at least partially between the base member 202 and the top member 204. During assembly, at least a portion of the isolator member 206 is disposed between the base member 202 and the top member 204 as shown in FIG. 6.

During operation, the exemplary shock mount 200 compensates for approximately 2 mm compression in the X-Y plane and also approximately 2 mm inclined drop active in the z plane. Moreover, the isolator member 206 may be tuned to vary the isolation between approximately 1 and 4 mm deflection. One example of tuning the isolator includes fabricating the isolator 206 using a different material such that isolation can be varied to compensate for more or less displacement. As such the shock mount 200 allows a relatively small amount of acceleration to be delivered to the panel 122 while limiting the movement of the panel 122 to avoid shearing the thermal interface material 114. The result is a small, tunable-stiffness, deflection-limiting shock mount 200 that exhibits near-equal stiffness in all three dimensions because of the shape of the isolator 206. Additionally, the isolator 206 is fabricated from a material that is soft enough to reduce the shock delivered to the panel, constrained enough to control the amount of movement that the panel experiences, shaped such that the stiffness is nearly the same in 3 dimensions, and has a stiffness that is tuned by using a harder or softer isolator material. Examples of such materials include rubber, plastic, and synthetic elastomers.

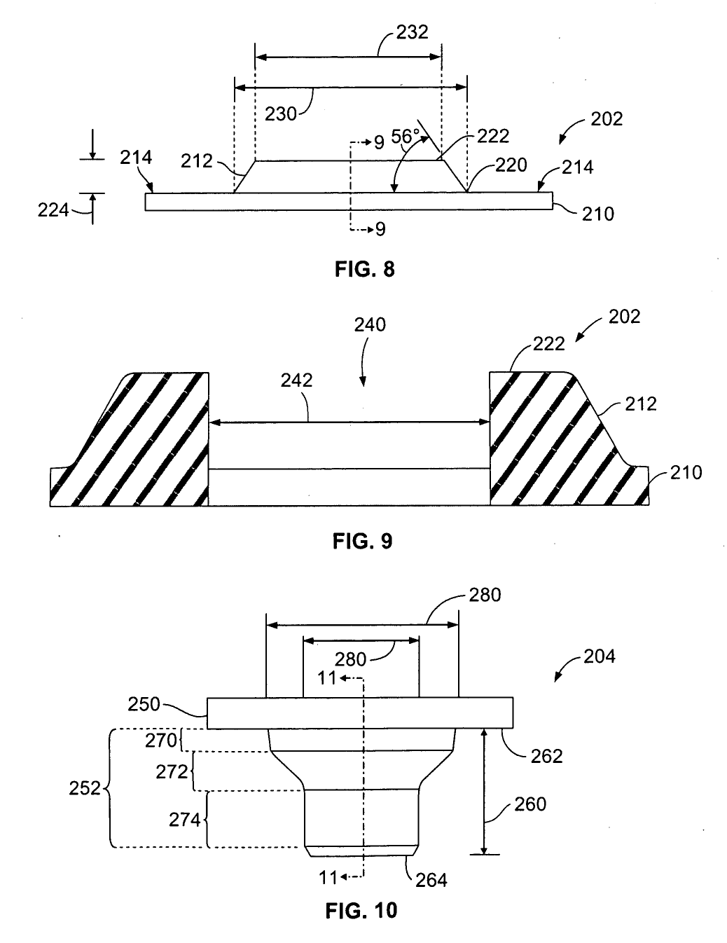

FIG. 8 is a side view of the base member 202. FIG. 9 is a cross-sectional view of the base member 202 taken along lines 9-9 of FIG. 8. As shown in FIG. 8, the base member 202 includes a mounting plate 210 and an isolator support structure 212. In the exemplary embodiment, the mounting plate 210 is formed unitarily with the support structure 212 using, for example, using a metal stamping procedure. Optionally, the mounting plate 210 may be coupled to the isolator support structure 212 using, for example, a welding or brazing procedure.

The mounting plate 210 includes a pair of openings 214, shown in FIG. 7, extending therethrough. In the exemplary embodiment, each opening 214 is adapted to receive a mechanical fastener therethrough that is utilized to secure the base member 202 to the panel support 120. As such, the openings 214 are utilized to couple the shock mount 200 to the panel support 120. As shown in FIGS. 9 and 10, the support structure 212 includes a first end 220 that is coupled to or formed with the mounting plate 210. The support structure 212 also includes an opposing second end 222 that is adapted to form a seat for the isolator 206. As such, the support structure 212 has a height 224 that extends from the first end 220 to the second end 222. In the exemplary embodiment, the second end 222 forms a surface which provides axially support for a portion of the isolator 206.

As shown in FIG. 8, the support structure first end 220 has a diameter 230 and the support structure second end 222 has a second diameter 232 that is less than the diameter 230. As such, the support structure has an outer profile that tapers radially inwardly from the first end 220 to the second end 222. In one embodiment, the taper is between approximately 50 degrees and approximately 60 degrees. In the exemplary embodiment, the taper is approximately 56 degrees. Other taper angles may also be utilized. The base member 202 also includes an opening 240 extending therethrough. In the exemplary embodiment, the opening 240 is approximately centrally located in the base member 202. The opening 240 has an inner diameter 242 that is approximately the same as an outer diameter of a portion of the isolator 206 such that the isolator 206 is friction fit with the support structure 212. Moreover, the diameter 242 of the opening 240 is substantially the same along the length of the opening 240. In the exemplary embodiment, the base member 202 is fabricated from a metallic material such as aluminum or stainless steel. Optionally, the base member 202 may be fabricated using a high-strength plastic material.

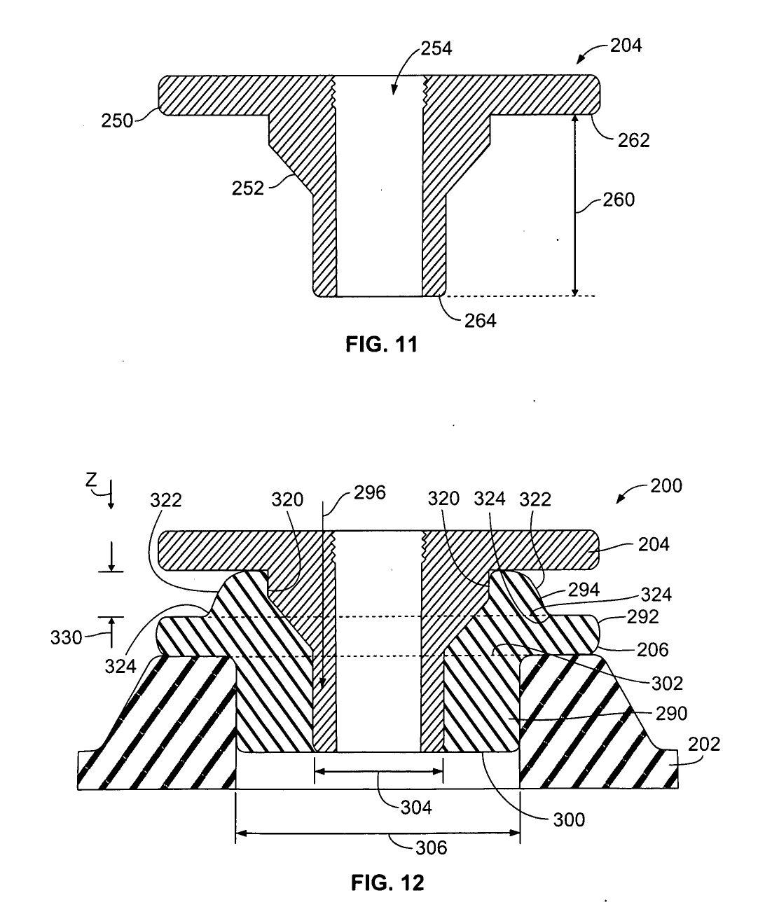

FIG. 10 is a side view of the top member 204. FIG. 11 is a cross-sectional view of the top member 204 taken along lines 11-11 of FIG. 10. As shown in FIG. 10, the top member 204 includes a top plate 250 and an isolator support structure 252. In the exemplary embodiment, the top plate 250 is formed unitarily with the isolator support structure 252. The top member 204 also includes a threaded opening 254 extending at least partially therethrough. In the exemplary embodiment, the threaded opening 254 is sized to receive the mechanical fastener 201 therein to secure a portion of the flexible shock mount 200 to the back cover 102. The isolator support structure 252 has a length 260 that extends from a lower surface 262 of the top plate 250 to a distal end 264. For purposes of explanation, the support structure 252 is characterized by three portions, e.g. a first portion 270, a second portion 272, and a third portion 274. It should be realized that in the exemplary embodiment, the portions 270-274 form a unitary structure. That is the portions 270-274 are formed as a single piece in a single molding operation or stamped as a single piece. As shown in FIG. 10, the first portion 270 extends from the lower surface 262 to the second portion 272. The first portion 270 has an outer diameter 280. The first portion outer diameter 280 is approximately equal to the inner diameter of a portion of the isolator 206 as discussed in more detail below. The second portion 272 extends from the first portion 270 to the third portion 274. The second portion 272 has an outer profile that tapers radially inwardly from the first portion 270 to the third portion 274. More specifically, one end of the second portion 272 has the same diameter as the first portion 270, i.e. diameter 280. Moreover, the opposing end of second portion 272 has an outer diameter 282 that is less than the first portion outer diameter 280 such that the second portion 272 tapers radially inwardly from the first portion 270 to the third portion 274. The third portion 274 also has the outer diameter 282. The outer surface of the support structure 252 is configured to provide support to the isolator 206 and to also limit the movement of the isolator 206.

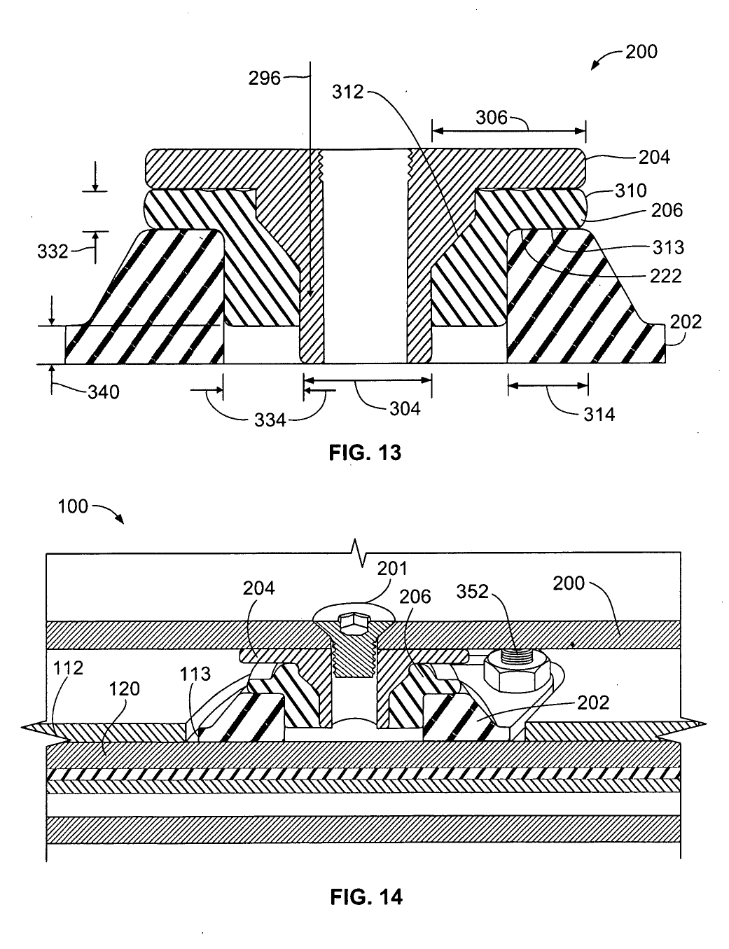

FIG. 12 is a cross-sectional view of the exemplary shock mount 200 shown in FIG. 6 in a first operational position. FIG. 13 is a cross-sectional view of the exemplary shock mount 200 shown in FIG. 6 or FIG. 12 in a second different operational position. As discussed above, the shock mount 200 includes the base member 202, the top member 204, and the isolator member 206 that is disposed at least partially between the base member 202 and the top member 204. In the exemplary embodiment, as shown in FIG. 12, the isolator member 206 includes an annulus portion 290, a pad 292, and a shock absorber 294. The isolator member 206 also includes an opening 296 extending therethrough that is sized to receive a portion of the top member 204. In the exemplary embodiment, the radially inner surface of the isolator member 206 is sized to form a friction fit with the radially outer surface of a portion of the top member 204. Moreover, the radially outer surface of the isolator member 206 forms a friction fit with at least a portion of the base member 202. For example, the isolator member 206 may be attached to the base member 202 using an adhesive, or the isolator member 206 may be insert-molded to the base member 202.

In the exemplary embodiment, the annulus portion 290, the pad 292, and the shock absorber 294 are formed as a unitary structure from a flexible material. More specifically, the isolator member 202 is fabricated from a material that has a stiffness that reduces shock delivered to the panel and also has a stiffness that limits the amount of movement that the panel experiences. For example, assuming that the panel includes nine shock mounts, the combined stiffness of the combined shock mounts is approximately 1.5*10⁶N/M.

As shown in FIGS. 12 and 13, the annulus portion 290 has a substantially cylindrical shape and includes a distal first end 300 and an opposing second end 302. As such, the annulus portion has an inner diameter 304 that is substantially the same as the outer diameter 282 of the top member third portion 274 shown in FIG. 10. Moreover, the annulus portion has an outer diameter 306 that is substantially the same as the inner diameter 242 of the opening 240 as shown in FIG. 9. Substantially the same as used herein, represents that both dimensions are sized to be approximately the same, but may vary based on the errors introduced in the fabrication process. For example, the outer diameter 306 is sized to be approximately the same as the inner diameter 242 such that the pieces contact each other during assembly and operation. Accordingly, in the exemplary embodiment, the annulus portion 290 is sized to be adhered to a portion of the top member 204 and a portion of the base member 202 as shown in FIGS. 12 and 13. Moreover, the profile of the annulus portion 290 is optimized to limit the movement of the top member 204 in both the X and Y axis directions.

As shown in FIG. 13, the pad 292 is substantially disc shaped and includes a radially inner surface 312 that has a profile that tapers and as such is complementary to the tapered profile of the second portion 272 of the top member 202. Moreover, the pad 292 also includes a portion 313 that forms a stop device that limits the travel or motion of the top member 204 with respect to the base member 202 as is discussed in more detail below. More specifically, the portion 312 has a width 314 that is approximately equal to the width of the second end of the support structure 212. As such, the support structure portion of the base member 202 functions as a stop device to limit the travel of movement of the top member 204.

The shock absorber 294 is formed with the pad 292 and as such is also formed with the annulus 290. In the exemplary embodiment, the shock absorber has a first side 320, a second side 322, and a bottom surface 324. The bottom surface 324 forms the connection between the shock absorber 294 and the pad 292. In the exemplary embodiment, the profile of the shock absorber 294 is optimized to limit the movement of the top member 204 in the Z-direction. More specifically, the second side 322 is tapered to optimize the amount of shock absorbed by the shock absorber 294.

In the exemplary embodiment, the isolator 206 is tunable such that the amount of shock absorbed by the flexible shock mount 200 is approximately the same in three different axes. Methods of tuning the isolator 206 include installing an isolator having a different height 330 of the shock absorber 294 into the shock mount 200. During operation, utilizing an isolator having an increased height 330 of the shock absorber 294 decreases the stiffness of the isolator 206. Whereas, utilizing an isolator having a decreased height 330 of the shock absorber 294 increases the stiffness of the isolator 206. Tuning the isolator also includes fabricating isolators having the shock absorber 294 positioned at different positions on the pad 292. For example, although FIGS. 12 and 13 illustrate the shock absorber 294 disposed proximate to an end of the pad 292, the shock absorber 294 may be disposed near the center of the pad 292 or at any location along the surface of the pad 292.

Other methods of tuning the isolator to affect stiffness include either increasing or decreasing a thickness 332 of the pad 292. For example, increasing the thickness 332 of the pad 292 decreases the amount of travel of the top member 204 in the Z-direction and thus increases the stiffness of the overall shock mount 200. Whereas decreasing the thickness 332 of the pad 292 increases the amount of travel of the top member 204 in the Z-direction and thus decreases the stiffness of the overall shock mount 200. Additionally, a thickness 334 of the annulus 290 may be modified to affect the overall stiffness of the isolator 206 in the X and Y directions. For example, increasing the thickness 334 of the annulus 290 increases the amount of travel of the top member 204 in the X and Y directions and thus decreases the stiffness of the overall shock mount 200. Whereas decreasing the thickness 334 of the annulus 290 decreases the amount of travel of the top member 204 in the X and Y directions and thus increases the stiffness of the overall shock mount 200. In the exemplary embodiment, the overall stiffness and thus the tuning modifications discussed herein are based on predetermined factors. Some predetermined factors may include for example, the size of the gap between the panel 122 and the front cover 110, the size of the gap between the panel 122 and the back cover 102, and/or the amount of movement that is calculated to resist breakage of the panel 122, etc.

During operation, when the shock mount 200 is at rest, such that no shock force is being applied to the shock mount 200, the top member 204 extends outwardly from the shock absorber 294 by the distance 330. That is, when no shock force is being applied to the shock mount 200, the shock absorber 294 is not compressed as shown in FIG. 12. Moreover, neither the annulus nor the pad are compressed and thus maintain a molded or original shape.

However, when a shock force is applied to the shock mount 200, the tuned isolator 206 is configured to absorb the shock substantially similarly in three axial directions as shown in FIG. 13. More specifically, the shock mount allows the panel to move approximately the same limited amount in three directions. For example, as shown in FIG. 13, when a shock force is applied to the shock mount 200 in the Z-direction, the shock absorber 294 is compressed until the top member 204 is contacting the pad 292. As such, in the Z-direction the shock absorber 294 is compressed by a distance 330 to enable the top member 204 to travel the same distance 332 further into the base member 202. For example, as shown in FIG. 13, when no shock forces are exerted on shock mount 200, a gap 340 is defined between the distal end of the top member 204 and the lower surface of the base plate 202. When the shock mount is subjected to a shock event in the Z-direction, the shock absorber 294 is compressed by a distance 330 to enable the top member 204 to travel the same distance 332 further into the base member 202 thus contacting the surface of the panel support 120. That is, the panel support 120 serves as a stop device limiting the amount of travel of the isolator 206 in the Z-direction. Additionally, the thickness of the annulus and the width of the pad may be modified to increase or decrease stiffness as described above.

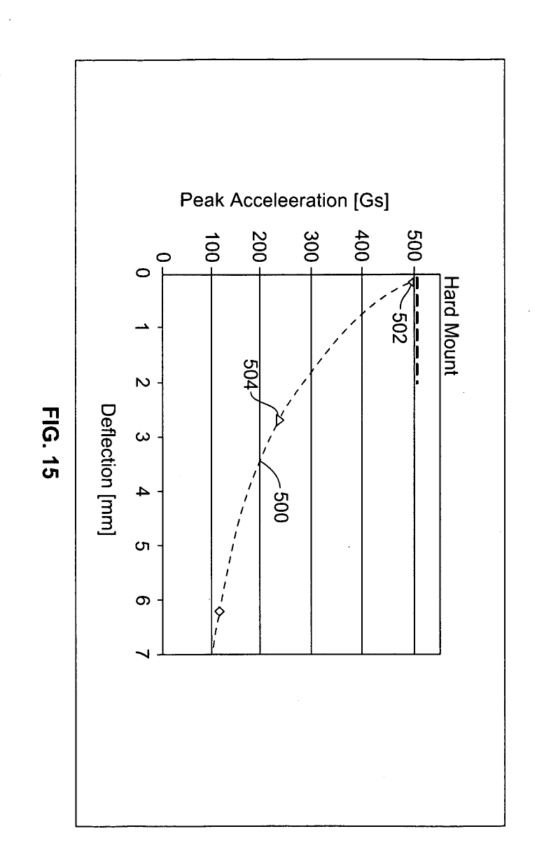

FIG. 14 is a cross-sectional view of the detector 100 shown in FIG. 3. During assembly, the base member 202 is coupled to the panel support 120. More specifically, the circuit board 122 includes an opening 113 extending therethrough that provides access to the panel support 120. As such, the circuit board 122 includes N openings 113 that are sized to receive N shock mount base member 202 therethrough to enable N shock mounts 200 to be installed in the detector 100. In the exemplary embodiment, the panel support 120 includes two studs 352 that are inserted through respective openings each in base member 202. The base member 202 is then secured to the panel support 120 utilizing, for example, a pair of nuts. It should be realized that other devices, such as screws or bolts, may be utilized to secure the base member 202 to the panel support 120. The top member 204 is then secured to the back cover 102 using the fastener 201 as described above.

FIG. 15 is a graphical illustration of the effect of tuning the shock mount 200 as described above wherein the X-axis represents the deflection of the panel assembly and the Y axis represents the peak acceleration of the panel assembly resulting from a shock event. For example, the line 500 represents the effect of shock on the detector. As shown in FIG. 15 at point 502, a conventional or hard mounted detector allows approximately 500 G's of acceleration to be applied to the detector. In this case, the detector may experience a failure as described above. Moreover, utilizing some embodiments of the shock mounts described herein, the peak acceleration is reduced to approximately 230 g's as shown at point 504. Moreover, the shock mount described herein may be tuned to increase the stiffness and thus reduce the deflection or decrease the stiffness and thus increase the deflection. For example, as shown in FIG. 15, increasing the stiffness of at least one shock mount moves the diamond point labeled 504 towards a more stiff configuration, e.g. left on the line 500. Whereas, decreasing the stiffness of at least one shock mount moves the point labeled 504 right along line 500 indicating that the overall stiffness of the detector shock configuration is reduced.

Described herein is a flexible shock mount assembly that may be utilized in a portable detector to provide limited deflection mechanical panel isolation. The flexible shock mount is an optimized panel isolation mount that limits panel movement while maintaining lower acceleration than conventional shock mounts. In the exemplary embodiment, the detector includes nine parallel mounts. Each shock mount includes two through holes in the base for receiving studs therethrough. A rigid top member is attached to the outer cover of the detector and the base member is attached to the panel support (which is not otherwise attached to the outer covers) as shown in the Figures. Both rigid parts are fixed to the isolator material using an adhesive, such as Loctite, or by co-molding the parts together.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the fill scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A shock mount assembly comprising:
a base member;
a top member; and
an isolator disposed between the base member and the top member, the isolator providing a dynamic stiffness in three different directions.

2. A shock mount assembly in accordance with claim 1, wherein the base member is adapted to be coupled to a detector panel support device and the top member is adapted to couple to a casing at least partially surrounding the panel support device.

3. A shock mount assembly in accordance with claim 1, wherein the isolator comprises:
a pad adapted to limit the movement of the shock mount assembly in a first direction; and
a shock absorber formed with the pad, the shock absorber adapted to limit the movement of the shock mount assembly in a different second direction.

4. A shock mount assembly in accordance with claim 3 further comprising an annulus formed with the pad, the annulus adapted to limit the movement of the shock mount assembly in a third different direction.

5. A shock mount assembly in accordance with claim 1, wherein the top member comprises a top plate and a structure support member formed with the top plate, the structure support configured to be at least partially inserted into an opening formed in the base member.

6. A shock mount assembly in accordance with claim 1, wherein the isolator comprises a shock absorber and a pad formed with the shock absorber, the pad having a predetermined thickness that limits the movement of the top member with respect to the base member.

7. A shock mount assembly in accordance with claim 1 wherein the base member comprises an opening extending therethrough, the opening sized to receive both a portion of the top plate and a portion of the isolator therethrough.

8. A shock mount assembly in accordance with claim 1 wherein the isolator member comprises an elastomeric isolator member.

9. A shock mount assembly in accordance with claim 1 wherein the isolator has a dynamic stiffness that is approximately the same in three different directions.

10. A shock mount assembly in accordance with claim 1 wherein the isolator has a dynamic stiffness that is selected to prevent a detector array from contacting a detector casing housing the detector array in three different directions.

11. A shock mount assembly in accordance with claim 1 wherein the isolator has a dynamic stiffness that is selected to prevent the thermal interface materials on an electronic assembly to shear past their shear strength.

12. A detector array assembly comprising:
an electronic assembly including a panel and a circuit board;
a panel support rigidly coupled to the electronic assembly;
a casing surrounding the electronic assembly and the panel support; and
a flexible shock mount assembly coupled between the panel support and the casing, the flexible shock providing a dynamic stiffness in three different directions.

13. A detector array assembly in accordance with claim 12, wherein the casing comprises:
a front cover; and
an opposing back cover coupled to the front cover, the at least one flexible shock mount coupled between the back cover and the panel support.

14. A detector array assembly in accordance with claim 12, further comprising a second flexible shock mount having a second dynamic stiffness that is substantially the same in three different directions, the second dynamic stiffness different than the dynamic stiffness of the flexible shock mount.

15. A detector array assembly in accordance with claim 12, wherein the circuit board comprises an opening extending therethrough to enable the flexible shock mount to couple directly to the panel support.

16. A detector array assembly in accordance with claim 12 further comprising a plurality of flexible shock mounts coupled between the casing and the panel support.

17. A detector array assembly in accordance with claim 12 wherein the panel comprises an array of photoelectric conversion elements deposited on a substrate and coated with a scintillator.

18. A detector array assembly in accordance with claim 12 further comprising a heat conducting material disposed between the electronic assembly and the casing, the heat conducting material configured to conduct heat away from the circuit board.

19. A detector array assembly in accordance with claim 12, wherein the detector array assembly comprises a portable detector array assembly.

20. A detector array in accordance with claim 12, wherein the flexible shock mount comprises:
a base member;
a top member; and
an isolator disposed between the base member and the top member, the isolator having a dynamic stiffness that is selected to prevent the electronic assembly from contacting the casing in three different directions.

21. A detector array in accordance with claim 12, wherein the flexible shock mount comprises an isolator disposed between a base member and a top member, the isolator comprises a pad adapted to limit the movement of the shock mount assembly in a first direction, and a shock absorber formed with the pad, the shock absorber adapted to limit the movement of the shock mount assembly in a different second direction.

22. A detector array in accordance with claim 12, wherein the flexible shock mount comprises:
a base member;
a top member; and
an isolator disposed between the base member and the top member, the isolator comprises a shock absorber and a pad formed with the shock absorber, the pad having a predetermined thickness that limits the movement of the top member with respect to the base member.

23. A method of dampening shock forces applied to a detector, the detector including an electronic assembly including a panel and a circuit board, a panel support rigidly coupled to the electronic assembly, and a casing surrounding the electronic assembly and the panel support, said method comprising:
determining a distance between the panel and the casing; and
configuring an isolator to have a dynamic stiffness that is substantially the same in three different directions, the dynamic stiffness being selected to limit the movement of the panel with respect to the casing to a quantity that is less than the distance between the panel and the casing.

24. A method in accordance with claim 23 wherein configuring the isolator comprises coupling the isolator between a top member and a base member to form a shock mount, the shock mount disposed between the panel support and the casing.

25. A method in accordance with claim 23 wherein the isolator includes a shock absorber coupled to a pad, said configuring the isolator further comprises:
determining the position of the shock absorber with respect to the pad based on a predetermined shock force; and
fabricating the shock absorber at the position on the pad based on the predetermined shock force.

26. A method in accordance with claim 23 further comprising coupling a plurality of isolators between the support panel and the casing.
